(19) United States
(12) Patent Application Publication
(10) Pub. No.: US 2018/0362801 A1
(43) Pub. Date: Dec. 20, 2018

(54) COATINGS WITH FAST RETURN TO SERVICE

(71) Applicant: Covestro LLC, Pittsburgh, PA (US)

(72) Inventors: Robert A. Wade, Oakdale, PA (US); Charles A. Gambino, McDonald, PA (US); Timothy Pike, Bethel Park, PA (US)

(21) Appl. No.: 15/626,267

(22) Filed: Jun. 19, 2017

(51) Int. Cl. C09D 175/12; C08G 18/34; C08G 18/38; C08G 18/73; C08G 18/79; C08G 18/72; C09D 5/00

(52) U.S. Cl. CPC C09D 175/12; C08G 18/346; C08G 18/3821; C09D 5/00; C08G 18/798; C08G 18/725; C08G 18/73

(57) ABSTRACT

The present invention provides a coating composition comprising 1% to 99% of a blend of two or more aspartic ester functional amines, 20% to 70% of an acrylate-containing compound; and 10% to 70% of one or more polyisocyanates, wherein the coating composition is 100% solids and wherein the coating composition has a maximum viscosity of no more than 600 cps at one hour. The ready-to-apply coating produced from this composition has extended working times without exhibiting “zippering” and may find use on countertops and floors.

### FIELD OF THE INVENTION

The present invention relates in general to coatings and more specifically to, coating compositions containing amino-functional polyaspartates and acrylate-containing compounds.

### BACKGROUND OF THE INVENTION

As those skilled in the art are aware, polyaspartate coatings have the advantages of fast cure times and therefore fast return to service; a high film build in one coat; good chemical and solvent resistance; good abrasion resistance; and the coatings are non-yellowing. A further advantage is that a 100% solids coating is possible with polyaspartate coatings. Unfortunately, polyaspartate coatings have the disadvantage of a short (less than 30 minutes) working time and a high viscosity.

On the other hand, UV-cured coatings have the advantages of fast cure times and therefore fast return to service; a high film build in one coat; excellent chemical and solvent resistance; good abrasion resistance; and are also non-yellowing. Further advantages of UV-cured coatings are that a 100% solids coating is possible; along with an unlimited working time and low viscosity. UV-cured coatings have the disadvantages of no physical drying and the potential for so-called “zipper” lines caused by UV-curing equipment.

To reduce or eliminate the disadvantages of each system, a need exists in the art for polyaspartate/UV-cured coatings which will retain the advantages of each system and have a one hour working time, a physical drying, low viscosity and no zipper lines.

### SUMMARY OF THE INVENTION

Accordingly, the present invention obviates problems inherent in the art by providing a coating comprising a combination of an aspartic ester functional amine and acrylate-containing compounds which can be blended to produce 100% solids, low viscosity materials. The blend can be mixed with polyisocyanates to produce ready-to-apply coatings with extended working times. In addition to the NCO/NH reaction, a photoinitiator may be aspartic ester functional amine added to the blend to provide a free radical reaction when exposed to UV light.

It is understood that the invention disclosed and described in this specification is not limited to the embodiments summarized in this Summary.

These and other advantages and benefits of the present invention will be apparent from the Detailed Description of the Invention herein below.

### DETAILED DESCRIPTION OF THE INVENTION

The present invention will now be described for purposes of illustration and not limitation. Except in the operating examples, or where otherwise indicated, all numbers expressing quantities, percentages, and so forth in the specification are to be understood as being modified in all instances by the term “about.”

Any numerical range recited in this specification is intended to include all sub-ranges of the same numerical precision subsumed within the recited range. For example, a range of “1.0 to 10.0” is intended to include all sub-ranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited in this specification is intended to include all lower numerical limitations subsumed therein and any minimum numerical limitation recited in this specification is intended to include all higher numerical limitations subsumed therein. Accordingly, Applicants reserve the right to amend this specification, including the claims, to expressly recite any sub-range subsumed within the ranges expressly recited herein. All such ranges are intended to be inherently described in this specification such that amending to expressly recite any such sub-ranges would comply with the requirements of 35 U.S.C. § 112(a), and 35 U.S.C. § 132(a).

Any patent, publication, or other disclosure material identified herein is incorporated by reference into this specification in its entirety unless otherwise indicated, but only to the extent that the incorporated material does not conflict with existing definitions, statements, or other disclosure material expressly set forth in this specification. As such, and to the extent necessary, the express disclosure as set forth in this specification supersedes any conflicting material incorporated by reference herein. Any material, or portion thereof, that is said to be incorporated by reference into this specification, but which conflicts with existing definitions, statements, or other disclosure material set forth herein, is only incorporated to the extent that no conflict arises between that incorporated material and the existing disclosure material. Applicants reserve the right to amend this specification to expressly recite any subject matter, or portion thereof, incorporated by reference herein.

Reference throughout this specification to “various non-limiting embodiments,” “certain embodiments,” or the like, means that a particular feature or characteristic may be included in an embodiment. Thus, use of the phrase “in various non-limiting embodiments,” “in certain embodiments,” or the like, in this specification does not necessarily refer to a common embodiment, and may refer to different embodiments. Further, the particular features or characteristics may be combined in any suitable manner in one or more embodiments. Thus, the particular features or characteristics illustrated or described in connection with various or certain embodiments may be combined, in whole or in part, with the features or characteristics of one or more other embodiments without limitation. Such modifications and variations are intended to be included within the scope of the present specification.

The grammatical articles “a”, “an”, and “the”, as used herein, are intended to include “at least one” or “one or more”, unless otherwise indicated, even if “at least one” or “one or more” is expressly used in certain instances. Thus, these articles are used in this specification to refer to one or more than one (i.e., to “at least one”) of the grammatical objects of the article. By way of example, and without limitation, “a component” means one or more components, and thus, possibly, more than one component is contemplated and may be employed or used in an implementation of the described embodiments. Further, the use of a singular noun includes the plural, and the use of a plural noun includes the singular, unless the context of the usage requires otherwise.

The present invention provides a blend of two or more aspartic ester functional amines and an acrylate-containing compound combined with a polyisocyanate to produce a ready-to-apply coating having extended working times without the cured coating exhibiting “zippering”. As used herein, the term “zippering” means a visible wave pattern where the thickness at the valleys of the wave is thinner than the thickness at a flat film area and the thickness at the peaks of the wave is thicker than the thickness at the flat film area. The difference between the thickness at the peak areas and the thickness at the valley areas is at least about 10 mμ. The terms “zippering”, “wrinkling”, and “buckling” are synonymous and are used interchangeably herein, as are the terms “zipper”, “wrinkle”, and “buckle”.

The polyisocyanate useful in the coating compositions of the present invention can be aromatic, araliphatic, aliphatic or cycloaliphatic di- and/or polyisocyanates and mixtures of such isocyanates. Preferred are diisocyanates of the formula R¹(NCO)₂, wherein R¹ represents an aliphatic hydrocarbon residue having 4 to 12 carbon atoms, a cycloaliphatic hydrocarbon residue having 6 to 15 carbon atoms, an aromatic hydrocarbon residue having 6 to 15 carbon atoms or an araliphatic hydrocarbon residue having 7 to 15 carbon atoms. Specific examples of suitable isocyanates include tetramethylene diisocyanate, hexamethylene diisocyanate, 2,3,3-trimethylhexamethylene diisocyanate, 1,4-cyclohexylene diisocyanate, 4,4′-dicyclohexylmethane diisocyanate, 4,4′-dicyclohexyl diisocyanate, 1-diisocyanato-3,3,5-trimethyl-5-isocyanatomethylcyclohexane (isophorone diisocyanate), 1,4-phenylene diisocyanate, 2,6-tolylene diisocyanate, 2,4-tolylene diisocyanate, 1,5-naphthylene diisocyanate, 2,4- or 4,4′-diphenylmethane diisocyanate, α,α,α′,α′-tetramethyl-m- or -p-xylylene diisocyanate, and triphenylmethane 4,4′,4″-triisocyanate as well as mixtures thereof.

Polyisocyanates having isocyanurate, biuret, allophanate, uretdione or carbodiimide groups are also useful as the isocyanate component of the present invention. Such polyisocyanates may have isocyanate functionalities of three or more and are prepared by the trimerization or oligomerization of diisocyanates or by the reaction of diisocyanates with polyfunctional compounds containing hydroxyl or amine groups. Preferred is the isocyanurate of hexamethylene diisocyanate. Further suitable compounds are blocked polyisocyanates, such as 1,3,5-tris-[6-(1-methyl-propylidene aminoxy carbonylamino)hexyl]-2,4,6-trioxo-hexahydro-1,3,5-triazine.

Hexamethylene diisocyanate, 4,4′-dicyclohexylmethane diisocyanate and 1-isocyanato-3,3,5-trimethyl-5-isocyanatomethylcyclohexane (isophorone diisocyanate; IPDI) and the mixtures thereof are the presently preferred isocyanates.

The terms aspartic ester functional amine, amino-functional polyaspartate and polyaspartate are used interchangeably in the present disclosure. Various embodiments of the coating compositions of the present invention include 1% to 99% of a blend of two or more aspartic ester functional amines and other embodiments include 20% to 70%, based on the weight of total composition. Aspartic ester functional amines useful in the coating compositions of the present invention are described in U.S. Pat. Nos. 5,126,170; 5,236,741; and 5,489,704, all incorporated herein by reference. These polyaspartates comprise compounds of formula (I):

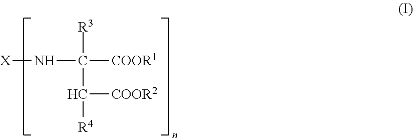

In compounds of formula (I), the residue X is preferably obtained from an n-valent polyamine selected from ethylenediamine, 1,2-diaminopropane, 1,4-diaminobutane, 1,6-diaminohexane, 2,5-diamino-2,5-dimethylhexane, 2,2,4- and/or 2,4,4-trimethyl-1,6-diaminohexane, 1,11-diaminoundecane, 1,12-diaminododecane, 1-amino-3,3,5-trimethyl-5-aminomethylcyclohexane, 2,4- and/or 2,6-hexahydrotoluylenediamine, 2,4′- and/or 4,4′-diaminodicyclohexylmethane, 3,3′-dimethyl-4,4′-diaminodicyclohexylmethane, 2,4,4′-triamino-5-methyldicyclohexylmethane and polyether polyamines with aliphatically bound primary amino groups and having a number average molecular weight Mₙ of 148 to 6000 g/mol.

The residue X is more preferably obtained from 1,4-diaminobutane, 1,6-diaminohexane, 2,2,4- and/or 2,4,4-trimethyl-1,6-diaminohexane, 1-amino-3,3,5-trimethyl-5-aminomethylcyclohexane, 4,4′-diaminodicyclohexylmethane or 3,3′-dimethyl-4,4′-diaminodicyclohexylmethane.

The phrase “inert to isocyanate groups under the reaction conditions,” which is used to define groups R¹ and R², means that these groups do not have Zerevitinov-active hydrogens (CH-acid compounds; cf. Römpp Chemie Lexikon, Georg Thieme Verlag Stuttgart), such as OH, NH or SH.

R¹ and R², independently of one another, are in some embodiments C₁ to C₁₀ alkyl residues, in certain embodiments methyl or ethyl residues. When X is the residue obtained from 2,4,4′-triamino-5-methyldicyclohexylmethane, R¹ and R² are preferably ethyl. R³ and R⁴ may be identical or different and represent hydrogen or organic groups which are inert towards isocyanate groups at a temperature of 100° C. or less, preferably hydrogen or C₁ to C₁₀ alkyl residues, more preferably hydrogen, methyl or ethyl residues. Most preferably, R³ and R⁴ are both hydrogen. In formula I), n is preferably an integer from 2 to 6, more preferably 2 to 4.

The production of aspartic ester functional amines takes place in known manner by reacting the corresponding primary polyamines of the formula (II):

XNH₂┘ₙ (II)

with maleic or fumaric acid esters of the formula (III):

R¹OOC—CR³═CR⁴—COOR² (III)

where R¹, R², R³ and R⁴ are as defined above for formula (I).

Suitable polyamines are the above-mentioned diamines or triamines (Examples include JEFFAMINE T-403 and NTA). Examples of suitable maleic or fumaric acid esters are dimethyl maleate, diethyl maleate, dibutyl maleate and the corresponding fumarates.

In various embodiments, the production of aspartic ester functional amines from the above-mentioned starting materials takes place within the temperature range of 0° C. to 100° C. The starting materials are used in amounts such that there is at least one, preferably one, olefinic double bond for each primary amino group. Any starting materials used in excess can be separated off by distillation following the reaction. The reaction can take place in the presence or absence of suitable solvents, such as methanol, ethanol, propanol, dioxane or mixtures thereof.

Suitable aspartic ester functional amines for use in the coating compositions of the present invention include those described in U.S. Pat. Nos. 5,126,170; 5,236,741; 5,489,704; 5,243,012; 5,736,604; 6,458,293; 6,833,424; 7,169,876; and in U.S. Patent Publication No. 2006/0247371, which are incorporated by reference into this specification. In addition, suitable aspartic ester functional amines are commercially available from Covestro LLC, Pittsburgh, Pa., USA, under the names DESMOPHEN NH 1220, DESMOPHEN NH 1420, DESMOPHEN NH 1520, DESMOPHEN NH 1521, DESMOPHEN NH 2850 XP.

The coating compositions of the present invention include one or more acrylate-containing compounds. In various embodiments, the coating compositions include 1% to 99% of the acrylate-containing compound and in certain other embodiments 20% to 70% of the acrylate-containing compound are included based on the weight of total composition. The acrylate-containing compound useful in the coating of the present invention are polycondensation products derived from polycarboxylic acids or the anhydrides thereof (such as, for example, adipic acid, sebacic acid maleic anhydride, fumaric acid and phthalic acid), di- and/or more highly functional polyols (such as for example ethylene glycol, propylene glycol, neopentyl glycol, trimethylol-propane, pentaerythritol, alkoxylated di- or polyols and the like) and acrylic and/or methacrylic acid. After polycondensation, excess carboxyl groups may be reacted with epoxides. Production of the acrylate-containing compound is described in U.S. Pat. No. 4,206,205, German Offenlegungschrifften 4,040,290, 3,316,592, and 3,704,098 and in UV & EB Curing Formulations for Printing Inks, Coatings & Paints, ed. R. Holman and P. Oldring, published by SITA Technology, London (England), 1988, pages 36 et seq. The reactions should be terminated once the OH number is within the range from 40 to 240. It is also possible to use polyepoxy acrylate polymers containing hydroxyl groups or polyurethane acrylate polymers containing hydroxyl groups. In various embodiments, the percentage of C═C can range from 0.1 moles/kg to 10 moles/kg, based on the weight of the acrylate polymer(s).

Suitable acrylate-containing compounds include all those described herein below, in connection with urethane acrylates and acrylate-functional polyisocyanates. Suitable acrylate-functional compounds can also have epoxy groups, an example of which is glycidyl(meth)acrylate, or the reaction products of equimolar amounts of acrylic or metacrylic acid and die oxide compounds, such as, for example, neopentylglycol diglycidyl ester. Reaction products of hydroxyl-containing, polymerizable monomers, such as, for example, hydroxyethyl acrylate, and diepoxides are also suitable. A preferred acrylate-containing compound is hexane diol diacrylate, sold under the name SARTOMER SR-238. The acrylate-containing compounds useful in the present invention may be monomeric or oligomeric.

The coating compositions of the present invention may further include initiators of a free-radical polymerization, which can be activated thermally and/or by radiation. Photoinitiators, which are activated by UV or visible light, are preferred in this context. Photoinitiators are compounds known in the art, being sold commercially, a distinction being made between unimolecular (type I) and bimolecular (type II) initiators. Suitable (type I) systems are aromatic ketone compounds, e.g. benzophenones in combination with tertiary amines, alkylbenzophenones, 4,4′-bis(dimethylamino)benzophenone (Michler's ketone), anthrone and halogenated benzophenones or mixtures of the types stated. Of further suitability are (type II) initiators such as benzoin and its derivatives, benzil ketals, acylphosphine oxides, 2,4,6-trimethylbenzoyldiphenylphosphine oxide for example, bisacylphosphine oxides, phenylglyoxylic esters, camphorquinone, α-aminoalkylphenones, α, α-dialkoxyacetophenones and α-hydroxyalkylphenones.

The initiators, which are used in amounts between 0.1% and 10% by weight in some embodiments and 0.1% to 5% by weight in other embodiments, based on the weight of the acrylate, can be used as an individual substance or, on account of frequent advantageous synergistic effects, in combination with one another.

Where electron beams—are used instead of UV radiation there is no need for a photoinitiator. Electron beams, as is known to the skilled person, are generated by means of thermal emission and accelerated by way of a potential difference. The high-energy electrons then pass through a titanium foil and are guided onto the binders to be cured. The general principles of electron beam curing are described in detail in “Chemistry & Technology of UV & EB Formulations for Coatings, Inks & Paints”, Vol. 1, P K T Oldring (Ed.), SITA Technology, London, England, pp. 101-157, 1991.

In the event of thermal curing of the activated double bonds, this can also take place with addition of thermally decomposing free-radical initiators. Suitability is possessed, as is known to the skilled person, by, for example, peroxy compounds such as dialkoxy dicarbonates such as, for example, bis(4-tert-butylcyclohexyl)-peroxydicarbonate, dialkyl peroxides such as, for example, dilauryl peroxide, peresters of aromatic or aliphatic acids such as, for example, tert-butyl perbenzoate or tert-amyl peroxy 2-ethylhexanoate, inorganic peroxides such as, for example, ammonium peroxodisulphate, potassium peroxodisulphate, organic peroxides such as, for example, 2,2-bis(tert-butylperoxy)butane, dicumyl peroxide, tert-butyl hydroperoxide or else azo compounds such as 2,2′-azobis[N-(2-propenyl)-2-methylpropionamides], 1-[(cyano-1-methylethyl)azo]formamides, 2,2′-azobis(N-butyl-2-methylpropionamides), 2,2′-azobis(N-cyclohexyl-2-methylpropionamides), 2,2′-azobis{2-methyl-N-[2-(1-hydroxybutyl)]propionamides}, 2,2′-azobis{2-methyl-N-[2-(1-hydroxybutyl)]propionamides, 2,2′-azobis{2-methyl-N-[1,1-bis(hydroxyl-methyl)-2-hydroxyethyl]propionamides. Also possible are highly substituted 1,2-diphenylethanes(benzpinacols), such as, for example, 3,4-dimethyl-3,4-diphenylhexane, 1,1,2,2-tetraphenylethane-1,2-diol or else the silylated derivatives thereof.

It is also possible to use a combination of initiators activable by UV light and thermally. The photoinitiator can be substantially any photoinitiator which preferably have a high photochemical reactivity and an absorption band in the near-UV range (>300 nm and particularly preferably >350 nm). A variety of photoinitiators can be utilized in the radiation-curing compositions of the present invention. The usual photoinitiators are those that generate free radicals upon exposure to radiation energy. Suitable photoinitiators may be chosen from amongst acylphosphine oxide derivatives, α-aminoalkylphenone derivatives, hydroxyalkylphenones, benzophenones, benzil ketals, methylbenzoyl formate and phenylacetophenones. Further suitable compounds include, for example, 2,4,6-trimethylbenzoyldiphenylphosphine oxide, phenylglyoxylic acid esters, anthraquinone and the derivatives thereof, benzil ketals and hydroxyalkylphenones. Illustrative of additional suitable photoinitiators are 2,2-diethoxyacetophenone; 2- or 3- or 4-bromoacetophenone; 3- or 4-allyl-acetophenone; 2-acetonaphthone; benzaldehyde; benzoin; the alkyl benzoin ethers; benzophenone; benzoquinone; 1-chloroanthra-quinone; p-diacetyl-benzene; 9,10-dibromoanthracene; 9,10-dichloro-anthracene; 4,4-dichlorobenzophenone; thioxanthone; isopropyl-thioxanthone; methylthioxanthone; α,α,α-trichloro-para-t-butyl aceto-phenone; 4-methoxybenzophenone; 3-chloro-8-nonylxanthone; 3-iodo-7-methoxyxanthone; carbazole; 4-chloro-4′-benzylbenzophenone; fluoroene; fluoroenone; 1,4-naphthylphenylketone; 1,3-pentanedione; 2,2-di-sec-butoxy acetophenone; dimethoxyphenyl acetophenone; propiophenone; isopropylthioxanthone; chlorothioxanthone; xanthone; maleimides and their derivatives; and mixtures thereof. There are several suitable photoinitiators commercially available from Ciba including IRGACURE 184 (1-hydroxy-cyclohexyl-phenyl-ketone), IRGACURE 819 (bis(2,4,6-trimethyl-benzoyl)-phenylphosphineoxide), IRGACURE 1850 (a 50/50 mixture of bis(2,6-dimethoxybenzoyl)-2,4,4-trimethylpentyl-phosphine oxide and 1-hydroxy-cyclohexyl-phenyl-ketone), IRGACURE 1700 (a 25/75 mixture of bis(2,6-dimethoxybenzoyl)-2,4,4-trimethylpentyl-phosphine oxide and 2-hydroxy-2-methyl-1-phenyl-propan-1-one), IRGACURE 907 (2-methyl-1[4-(methylthio)phenyl]-2-morpholonopropan-1-one), DAROCUR MBF (a phenyl glyoxylic acid methyl ester) and DAROCUR 4265 (a 50/50 mixture of bis(2,4,6-trimethylbenzoyl)-phenylphosphineoxide and 2-hydroxy-2-methyl-1-phenyl-propan-1-one). The foregoing lists are meant to be illustrative only and are not meant to exclude any suitable photoinitiators.

As is known in the art and depending on the application for the coating, additional additives can be used. Such additives include, but are not limited to, emulsifiers, dispersing agents, flow aid agents, thickening agents, defoaming agents, deaerating agents, pigments, fillers, flattening agents and wetting agents.

Curing of the coatings according to the invention is carried out by exposure to actinic radiation, preferably by exposure to high-energy radiation, i.e. UV radiation or daylight, e.g. light with a wavelength of 200 nm to 750 nm, or by bombardment with high-energy electrons (electron beams, 150 keV to 300 keV). Examples of radiation sources used for light or UV light include high-pressure mercury vapor lamps. It is possible for the mercury vapor to have been modified by doping with other elements such as gallium or iron. Lasers, pulsed lamps (known under the designation UV flashlight lamps), halogen lamps or excimer emitters are also suitable. UV-A curing can be effected with a PANACOL UV-F 900 UV-A lamp from Panacol-Elosol GmbH, Germany. The lamps may be stationary so that the material to be irradiated is moved past the radiation source by means of a mechanical apparatus, or the lamps may be mobile and the material to be irradiated remains stationary in the course of curing. The radiation dose that is normally sufficient for crosslinking in the case of UV curing is 80 mJ/cm² to 5000 mJ/cm².

The nature and concentration of any initiator used are to be varied in known manner in accordance with the radiation dose and curing conditions. For applications that are cured with sunlight, photoinitiators that are activated by one or both of UV-A and visible light are preferred. The type and concentration of photoinitiator must be adapted, in a manner known to those skilled in the art, according to the radiation source used for curing.

Coatings made from the inventive coating composition may find use in a variety of applications including floor and countertop coatings.

### EXAMPLES

The non-limiting and non-exhaustive examples that follow are intended to further describe various non-limiting and non-exhaustive embodiments without restricting the scope of the embodiments described in this specification. All quantities given in “parts” and “percents” are understood to be by weight, unless otherwise indicated.

The following materials were used in preparing the compositions of the Examples:

| POLYASPARTATE A | a 100% solids content aspartic ester functional |
|---|---|
| | amine, having an amine number of approx. 201 |
| | mg KOH/g, viscosity @ 25° C. of 1450 mPa · s, |
| | commercially available from Covestro LLC as |
| | DESMOPHEN NH 1420; |
| POLYASPARTATE B | a 100% solids content aspartic ester functional |
| | amine, having an amine number of approx. 191 |
| | mg KOH/g, viscosity @ 25° C. of 1400, |
| | commercially available from Covestro LLC as |
| | DESMOPHEN NH 1520; |
| POLYASPARTATE C | a 100% solids content aspartic ester functional |
| | amine, having an amine number of approx. 190 |
| | mg KOH/g, viscosity @ 25° C. of 100 mPa · s, |
| | commercially available from Covestro LLC as |
| | DESMOPHEN NH 2850 XP; |
| ISOCYANATE A | an aliphatic polyisocyanate resin based on |
| | hexamethylene diisocyanate, NCO content |
| | 23.5 ± 0.5%, viscosity 730 ± 100 mPa · s @ |
| | 23° C., commercially available from Covestro |
| | LLC as DESMODUR N-3900; |
| ISOCYANATE B | a low viscosity solvent-free aliphatic |
| | polyisocyanate (HDI uretdione) resin, NCO |
| | content 21.8 ± 0.7, viscosity 175 ± 75 @ 23° C., |
| | commercially available from Covestro LLC as |
| | DESMODUR N-3900 as DESMODUR N-3400 |
| SURFACTANT A | a polyacrylate-based surface additive, |
| | commercially available from BYK Chemie as |
| | BYK-354; |
| PHOTOINTIATOR A | a liquid 50/50 mixture of bis(2,4,6- |
| | trimethylbenzoyl)-phenylphosphineoxide and 2- |
| | hydroxy-2-methyl-1-phenyl-propan-1-one, |
| | commercially available from BASF as |
| | DAROCUR 4265; |
| ACRYLATE A | 1,6 hexanediol diacrylate, commercially |
| | available from Sartomer as SR-238; |
| ACRYLATE B | pentaerythritol (EO)ₙ tetraacrylate, |
| | commercially available from Miwon Specialty |
| | Chemical Co. as MIRAMER M4004; |
| ACRYLATE C | isobornyl acrylate, commercially available from |
| | Sartomer as SR-506; |
| ACRYLATE D | tripropylene glycol diacrylate (TIEGDA), |
| | commercially available from Sartomer as SR- |
| | 306; |
| ACRYLATE E | trimethylolpropane triacrylate (TMPTA), |
| | commercially available from Sartomer as SR- |
| | 351. |

### Example 1—Initial Screening

The coating composition of EXAMPLE 1-A contained POLYASPARTATE A alone; EXAMPLE 1-B contained POLYASPARTATE B alone; EXAMPLE 1-C contained POLYASPARTATE A (70 parts) and ACRYLATE A (30 parts); EXAMPLE 1-D contained POLYASPARTATE A (35 parts), POLYASPARTATE C (30 parts) and ACRYLATE A (30 parts); EXAMPLE 1-E contained POLYASPARTATE C (50 parts) and ACRYLATE A (50 parts); EXAMPLE 1-F contained POLYASPARTATE A (20 parts), POLYASPARTATE C (40 parts) and ACRYLATE A (40 parts); and EXAMPLE 1-G contained POLYASPARTATE B (20 parts), POLYASPARTATE C (40 parts) and ACRYLATE A (40 parts).

Viscosity measurements were made over one hour with a Brookfield viscometer to give an indication of pot-life. Surface dry-time was measured at 10 mil thickness draw down with a 12-hour dry-time meter. Hardness was measured at UV 10 mils thickness draw down with a pendulum hardness device. Gasoline resistance or isopropyl alcohol (IPA) resistance was assessed at one hour by soaking a cotton ball in gasoline or IPA, placing the cotton ball on the coating surface and covering it with a watch glass.

TABLE I

| EXAMPLE | 1-A | 1-B | 1-C | 1-D | 1-E | 1-F | 1-G |
|---|---|---|---|---|---|---|---|
| Initial viscosity | 1028 | 1436 | 261 | 163 | 50 | 81 | 84 |
| Viscosity @ | gel | 1656 | 1900 | 378 | 61 | 159 | 130 |
| 15 min. | | | | | | | |
| Viscosity @ | | 3500 | | 2000 | 98 | 386 | 183 |
| 30 min. | | | | | | | |
| Viscosity @ | | n.a. | | | n.a. | 970 | 300 |
| 45 min. | | | | | | | |
| Viscosity @ | | 4300 | | | 223 | | 550 |
| 60 min. | | | | | | | |
| Surface dry | 15 | >10 hr. | 75 | 140 | >4 hr. | 2-3 hr. | 7 hr. |
| time (min.) | | | | | | | |
| Hardness (sec) | 168 | 176 | 151 | 137 | 38 | 78 | 66 |
| Gasoline | swell | swell | swell | swell | swell | swell | swell |
| resistance | | | | | | | |
| IPA resistance | swell | swell | swell | swell | swell | swell | swell |

Table I summarizes the results of the aspartic ester functional amine/UV hybrid initial screening. The objectives of the initial screening were to find if a coating composition would have a one-hour working time (i.e., a viscosity of ˜500-600 cps max @ 1 hour), 100% solids, overnight return to service, good hardness, abrasion and chemical resistance, a one-coat application @ 5 to 10 mils dry with no zipper lines from UV cure. As is apparent by reference to Table I, the coating compositions produced in EXAMPLES 1-D, 1-E, 1-F and 1-G were able to achieve the desired viscosity at some point in the hour, with EXAMPLES 1-E and 1-G achieving that viscosity over the entire hour.

### Example 2

Formulations of the coatings compositions are presented in Table II and testing results are presented in Table III. For measurements of EXAMPLE 2, the coatings were cured overnight at constant temperature of 70° F. (21.1° C.) and 50% relative humidity. Pot-Ii fe was a measurement of Brookfield viscosity increase over time up to 800 cps of a 2 ounce jar. Dry-time measurements were made on 5 mils wet samples on glass with a 12-hour meter. Pendulum hardness testing was conducted on 5 mils wet on glass. Taber abrasion was measured with a CS-17 wheel, 1000 grams, 500 cycles (used #50 wire bar). Gasoline resistance was determined after one hour exposure (5 mil drawdown bar). IPA resistance was determined after one hour exposure (5 mil drawdown bar). UV-curing was done by identifying the ft. per minute for 800+/−25 mJ (UV-cure next day).

TABLE II

| | EXAMPLE | | | | | | | | | |
|---|---|---|---|---|---|---|---|---|---|---|
| | 2-A | 2-B | 2-C | 2-D | 2-E | 2-F | 2-G | 2-H | 2-I | 2-J |
| | Weight | Weight | Weight | Weight | Weight | Weight | Weight | Weight | Weight | Weight |
| Component 1 | | | | | | | | | | |
| POLYASPARTATE A | | 6.78 | | 11.13 | | 7.28 | 13.77 | 10.56 | 15.02 | 14.38 |
| POLYASPARTATE B | 24.96 | 30.55 | 48.66 | 29.61 | 50.08 | 46.82 | | | 60.07 | 57.54 |
| POLYASPARTATE C | 49.98 | 30.6 | 25.26 | 14.9 | 24.99 | | 55.05 | 42.23 | | |
| ACRYLATE A | 24.98 | 31.68 | 24.65 | 55.65 | 25.02 | 54.09 | 35.36 | 52.79 | 25.03 | 23.97 |
| PHOTOINTIATOR A | 1.49 | 1.42 | 0.74 | 2.22 | 1.50 | 1.62 | 1.06 | 2.11 | 1.50 | 1.44 |
| Subtotal | 101.41 | 101.03 | 99.31 | 113.50 | 101.60 | 109.80 | 105.24 | 107.69 | 101.62 | 97.33 |
| Component 2 | | | | | | | | | | |
| ISOCYANATE A | 36.44 | 42.81 | 50.69 | 27.38 | 40.30 | 40.20 | 37.62 | 38.74 | 48.38 | 39.50 |
| ISOCYANATE B | 12.15 | 6.16 | | 9.12 | 8.10 | | 7.14 | 3.57 | | 13.17 |
| Subtotal | 48.59 | 48.97 | 50.69 | 36.50 | 48.40 | 40.20 | 44.76 | 42.31 | 48.38 | 52.67 |
| Total | 150.00 | 150.00 | 150.00 | 150.00 | 150.00 | 150.00 | 150.00 | 150.00 | 150.00 | 150.00 |
| Theoretical Results | | | | | | | | | | |
| Weight Solids | 100 | 100 | 100 | 100 | 100 | 100 | 100 | 100 | 100 | 100 |
| Wt/Gal | 9.00 | 8.99 | 9.01 | 8.87 | 9.00 | 8.89 | 8.96 | 8.92 | 9.00 | 9.02 |
| Volume Solids | 100.00 | 100.02 | 100.00 | 100.03 | 100.00 | 100.02 | 100.03 | 100.02 | 100.03 | 100.03 |
| Mix Ratio (volume) | 2.29:1 | 2.27:1 | 2.15:1 | 3.44:1 | 2.30:1 | 3.03:1 | 2.58:1 | 2.81:1 | 2.31:1 | 2.03:1 |
| P/B | 0 | 0 | 0 | 0 | 0 | 0 | 0 | 0 | 0 | 0 |
| NCO:OH | 1.05 | 1.17 | 1.13 | 1.05 | 1.05 | 1.21 | 1.05 | 1.30 | 1.05 | 1.17 |
| | EXAMPLE | | | | | | | | | |
| | 2-K | 2-L | 2-M | 2-N | 2-O | 2-P | 2Q | 2-R | 2-S | 2-T |
| | Weight | Weight | Weight | Weight | Weight | Weight | Weight | Weight | Weight | Weight |
| Component 1 | | | | | | | | | | |
| POLYASPARTATE A | 6.33 | | 8.71 | | | | 13.64 | | 3.16 | 13.89 |
| POLYASPARTATE B | 28.50 | | | 69.96 | 62.10 | | | | 14.25 | |
| POLYASPARTATE C | 28.53 | 55.08 | 59.97 | | | 59.13 | 54.57 | 53.67 | 44.95 | 55.56 |
| ACRYLATE A | 39.20 | 55.08 | 35.23 | 23.32 | 45.36 | 43.67 | 35.02 | 53.67 | 38.61 | 23.15 |
| PHOTOINTIATOR A | 1.76 | 1.65 | 2.11 | 0.70 | 2.72 | 2.62 | 2.10 | 3.22 | 2.02 | 1.39 |
| Subtotal | 104.32 | 111.82 | 106.03 | 93.97 | 110.19 | 105.42 | 105.33 | 110.55 | 103.00 | 94.00 |
| Component 2 | | | | | | | | | | |
| ISOCYANATE A | 39.93 | 31.61 | 43.97 | 46.65 | 36.82 | 33.44 | 33.50 | 39.45 | 44.13 | 46.63 |
| ISOCYANATE B | 5.75 | 6.56 | | 9.37 | 3.00 | 11.14 | 11.17 | | 2.87 | 9.37 |
| Subtotal | 45.68 | 38.18 | 43.97 | 56.03 | 39.81 | 44.58 | 44.67 | 39.45 | 47.00 | 56.00 |
| Total | 150.00 | 150.00 | 150.00 | 150.00 | 150.00 | 150.00 | 150.00 | 150.00 | 150.00 | 150.00 |
| Theoretical Results | | | | | | | | | | |
| Weight Solids | 100 | 100 | 100 | 100 | 100 | 100 | 100 | 100 | 100 | 100 |
| Wt/Gal | 8.96 | 8.89 | 8.97 | 9.03 | 8.91 | 8.95 | 8.97 | 8.91 | 8.97 | 9.05 |
| Volume Solids | 100.01 | 100.00 | 100.02 | 100.00 | 100.00 | 100.00 | 100.03 | 100.00 | 100.01 | 100.03 |
| Mix Ratio (volume) | 2.52:1 | 3.24:1 | 2.65:1 | 1.84:1 | 3.06:1 | 2.60:1 | 2.59:1 | 3.10:1 | 2.41:1 | 1.84:1 |
| P/B | 0 | 0 | 0 | 0 | 0 | 0 | 0 | 0 | 0 | 0 |
| NCO:OH | 1.17 | 1.13 | 1.05 | 1.30 | 1.05 | 1.22 | 1.05 | 1.21 | 1.23 | 1.30 |
| PVC | 0 | 0 | 0 | 0 | 0 | 0 | 0 | 0 | 0 | 0 |
| Theoretical VOC | 0 | 0 | 0 | 0 | 0 | 0 | 0 | 0 | 0 | 0 |
| | EXAMPLE | | | | | | | | | |
| | 2-U | 2-V | 2-W | 2-X | 2-Y | 2-Z | 2-AA | 2-AB | 2-AC | 2-AD |
| | Weight | Weight | Weight | Weight | Weight | Weight | Weight | Weight | Weight | Weight |
| Component 1 | | | | | | | | | | |
| POLYASPARTATE A | 6.32 | | | 5.22 | 9.33 | 12.79 | | | 12.21 | |
| POLYASPARTATE B | 57.01 | | 18.74 | 47.05 | 60.76 | 32.60 | 52.98 | 68.84 | 48.86 | 23.43 |
| POLYASPARTATE C | | 64.57 | 37.31 | | | 18.57 | | | | 46.93 |
| ACRYLATE A | 39.18 | 33.35 | 56.05 | 52.26 | 23.37 | 33.04 | 52.98 | 35.39 | 37.84 | 23.45 |
| PHOTOINTIATOR A | 1.76 | 1.23 | 2.24 | 3.14 | 0.70 | 0.99 | 2.12 | 1.06 | 2.27 | 0.70 |
| Subtotal | 104.3 | 99.15 | 114.3 | 107.7 | 94.16 | 97.99 | 108.1 | 105.3 | 101.2 | 94.51 |
| Component 2 | | | | | | | | | | |
| ISOCYANATE A | 39.98 | 50.85 | 35.66 | 31.75 | 55.84 | 39.01 | 41.91 | 33.53 | 48.81 | 55.49 |
| ISOCYANATE B | 5.75 | | | 10.58 | | 13.00 | | 11.18 | | |
| Subtotal | 45.73 | 50.85 | 35.66 | 42.33 | 55.84 | 52.01 | 41.91 | 44.71 | 48.81 | 55.49 |
| Total | 150.00 | 150.00 | 150.00 | 150.00 | 150.00 | 150.00 | 150.00 | 150.00 | 150.00 | 150.00 |
| Theoretical Results | | | | | | | | | | |
| Weight Solids | 100 | 100 | 100 | 100 | 100 | 100 | 100 | 100 | 100 | 100 |
| Wt/Gal | 8.95 | 9.00 | 8.88 | 8.91 | 9.04 | 9.00 | 8.91 | 8.95 | 8.97 | 9.04 |
| Volume Solids | 100 | 100.00 | 100.00 | 100 | 100 | 100 | 100.00 | 100.00 | 100 | 100.00 |
| Mix Ratio (volume) | 2.51:1 | 2.15:1 | 3.55:1 | 2.81:1 | 1.85:1 | 2.07:1 | 2.86:1 | 2.59:1 | 2.29:1 | 1.87:1 |
| P/B | 0 | 0 | 0 | 0 | 0 | 0 | 0 | 0 | 0 | 0 |
| NCO:OH | 1.17 | 1.30 | 1.05 | 1.30 | 1.30 | 1.30 | 1.30 | 1.05 | 1.30 | 1.30 |

| | EXAMPLE | | | | |
|---|---|---|---|---|---|
| | 2-AE | 2-AF | 2AG | 2-AH | 2-AI |
| | Weight | Weight | Weight | Weight | Weight |
| Component 1 | | | | | |
| POLYASPARTATE A | 4.64 | 6.78 | 14.38 | | |
| POLYASPARTATE B | | 30.56 | | 72.65 | |
| POLYASPARTATE C | 66.98 | 30.59 | 57.53 | | 75.52 |
| ACRYLATE A | 23.88 | 31.68 | 23.97 | 24.22 | 25.17 |
| PHOTOINTIATOR A | 0.72 | 1.42 | 0.72 | 1.45 | 1.01 |
| Subtotal | 96.22 | 101 | 96.6 | 98.32 | 101.7 |
| Component 2 | | | | | |
| ISOCYANATE A | 40.34 | 42.8 | 53.4 | 51.68 | 44.24 |
| ISOCYANATE B | 13.45 | 6.16 | | | 4.07 |
| Subtotal | 53.78 | 48.96 | 53.4 | 51.68 | 48.31 |
| Total | 150.00 | 150.00 | 150.00 | 150.00 | 150.00 |
| Theoretical Results | | | | | |
| Weight Solids | 100 | 100 | 100 | 100 | 100 |
| Wt/Gal | 9.03 | 8.99 | 9.04 | 9.01 | 9.01 |
| Volume Solids | 100 | 100 | 100 | 100.00 | 100.00 |
| Mix Ratio (volume) | 1.96:1 | 2.27:1 | 1.98:1 | 2.09:1 | 2.31:1 |
| P/B | 0 | 0 | 0 | 0 | 0 |
| NCO:OH | 1.21 | 1.17 | 1.21 | 1.17 | 1.05 |

TABLE III

| | | | | | | | | | | | | Dry-time | | | | | |
|---|---|---|---|---|---|---|---|---|---|---|---|---|---|---|---|---|---|
| | Pot-life (Viscosity cps up to 800 cps) | | | | | | | | | | | (hrs.) | | Pendulum Hardness (sec.) | | | |
| EX. | Initial | 15 m | 30 m | 45 m | 60 m | 1.5 hr | 2 hr | 2.5 hr | 3 hr | 800 cps. | | Hard dry | | 1 day | 3-5 days | | 7 days |
| 2-A | 168 | 280 | 476 | 846 | | | | | | 45 | m | 3 | hr | 73 | 5 days | 92 | 100 |
| 2-B | 166 | 245 | 404 | 750 | | | | | | 50 | m | 10 | hr | 75 | 5 days | 112 | 131 |
| 2-C | 256 | 388 | 560 | 750 | | | | | | 50 | m | >12 | hr | 39 | 5 days | 66 | 132 |
| 2-D | 71 | 92 | 146 | 177 | 208 | 345 | 544 | 750 | | 2.5 | hr | >12 | hr | 120 | 5 days | 175 | 176 |
| 2-E | 240 | 312 | 435 | 552 | 765 | | | | | 60 | m | >12 | | 52 | 5 days | 151 | 163 |
| 2-F | 91 | 117 | 145 | 166 | 210 | 290 | 351 | 431 | 523 | >3 | hr. | >12 | hr | 130 | 5 days | 182 | 172 |
| 2-G | 85 | 152 | 304 | 580 | 915 | | | | | 55 | m | 2 | hr | 24 | 4 days | 28 | 28 |
| 2-H | 60 | 100 | 177 | 310 | 447 | 930 | | | | 1.5 | hr | 2 | hr | 83 | 4 days | 86 | 97 |
| 2-I | 318 | 512 | 836 | | | | | | | 30 | m | >12 | hr | 149 | 4 days | 203 | 185 |
| 2-J | 269 | 440 | 644 | 912 | | | | | | 45 | m | >12 | hr | 109 | 3 days | 146 | 173 |
| 2-K | 100 | 163 | 250 | 383 | 682 | 1015 | | | | 1.5 | hr | 10.5 | hr | 82 | 3 days | 113 | 141 |
| 2-L | 53 | 74 | 121 | 188 | 267 | 532 | 943 | | | 2 | hr | 2.5 | hr | 40 | 3 days | 55 | 58 |
| 2-M | 112 | 203 | 365 | 856 | | | | | | 40 | m | 1 hr 15 m | | 144 | 4 days | 124 | 157 |
| 2-N | 282 | 350 | 442 | 493 | 580 | 810 | | | | 1.5 | hr | 12 | hr | 32 | 4 days | 91 | 111 |
| 2-O | 119 | 135 | 148 | 190 | 201 | 252 | 310 | 400 | | >3 | hr. | >12 | hr | 114 | 4 days | 202 | 185 |
| 2-P | 65 | 106 | 167 | 284 | 410 | 819 | | | | 1.5 | hr | 2 | hr | 57 | 2 days | 30* | 40 |
| 2-Q | 96 | 227 | 489 | 906 | | | | | | 45 | m | 2 | hr | 114 | 2 days | 108* | 51 |
| 2-R | 53 | 71 | 106 | 156 | 224 | 484 | 831 | | | 2 | hr | 2 | hr | 80 | 2 days | 53* | 63 |
| 2-S | 92 | 138 | 222 | 356 | 600 | 855 | | | | 70 | m | 4 | hr | 38 | 4 days | 61 | 35 |
| 2-T | 138 | 421 | 1032 | | | | | | | 25 | m | 1 hr 45 m | | 64 | 4 days | 52 | 25 |
| 2-U | 146 | 190 | 240 | 307 | 375 | 529 | 745 | | | 2 | hr | >12 | hr | 57 | 4 days | 139 | 148 |
| 2-V | 103 | 170 | 316 | 588 | 1060 | | | | | 1 | hr | 9 | hr | 20 | 4 days | 24 | 38 |
| 2-W | 54 | 68 | 93 | 127 | 170 | 291 | 400 | 579 | 730 | >3 | hr. | 6.75 | hr | 53 | 4 days | 85 | 89 |
| 2-X | 82 | 100 | 123 | 148 | 176 | 234 | 298 | 348 | 406 | >3 | hr. | >12 | hr | 99 | 4 days | 167 | 178 |
| 2-Y | 343 | 489 | 715 | 997 | | | | | | 45 | m | >12 | hr | 58 | 4 days | 157 | 173 |
| 2-Z | 135 | 240 | 406 | 720 | 1054 | | | | | 1 | hr | >12 | hr | 66 | 5 days | 131 | 148 |
| 2-AA | 77 | 84 | 92 | 105 | 116 | 151 | 191 | 212 | 256 | >3 | hr. | >12 | hr | 137 | 5 days | 180 | 180 |
| 2-AB | 144 | 165 | 198 | 223 | 261 | 364 | 423 | 563 | 648 | >3 | hr. | >12 | hr | 92 | 5 days | 163 | 170 |
| 2-AC | 137 | 210 | 357 | 475 | 630 | 760 | | | | 1 hr 15 m | | >12 | hr | 143 | 5 days | 181 | 176 |
| 2-AD | 133 | 177 | 448 | 841 | | | | | | 45 | m | 5.75 | hr | 25 | 5 days | 61 | 77 |
| 2-AE | 95 | 211 | 655 | 1656 | | | | | | 45 | m | 1.5 | hr | 30 | 4 days | 28 | 39 |
| 2-AF | 149 | 226 | 389 | 635 | 1044 | | | | | 1 | hr | 8.75 | hr | 65 | 4 days | 116 | 142 |
| 2-AG | 152 | 352 | 855 | | | | | | | 45 | m | 1 | hr | 89 | 4 days | 88 | 108 |
| 2-AH | 348 | 380 | 470 | 550 | 640 | 805 | | | | 1 hr 15 m | | >12 | hr | 119 | 4 days | 166 | 193 |
| 2-AI | 111 | 234 | 515 | 1035 | | | | | | 45 | m | 2 | hr | 49 | 4 days | 43 | 44 |

| | | | | | | | | | Taber Abrasion |
|---|---|---|---|---|---|---|---|---|---|
| | Gasoline resistance | | | | IPA resistance | | | | (mg lost) |
| EX. | 1 day | 3-5 days | | 7 days | 1 day | 3-5 days | | 7 days | CS-17 500 cy. |
| 2-A | soft | 5 days | soft | soft | soft | 5 days | soft | no effect | 24.0 |
| 2-B | soft | 5 days | soft | soft | soft | 5 days | soft | slightly soft | 28.0 |
| 2-C | soft | 5 days | soft | soft | soft | 5 days | soft | soft | 10.5 |
| 2-D | sl. soft | 5 days | slightly soft | no effect | slightly soft | 5 days | slightly soft | no effect | 21.5 |
| 2-E | soft | 5 days | soft | soft | soft | 5 days | soft | soft | 9.0 |
| 2-F | soft | 5 days | soft | very slightly | soft | 5 days | soft | no effect | 7.0 |
| | | | | soft | | | | | |
| 2-G | soft | 4 days | soft | soft | soft | 4 days | soft | slightly soft | 4.0 |
| 2-H | very sl. | 4 days | very slightly | no effect | very slightly | 4 days | very slightly | no effect | 9.0 |
| | soft | | soft | | soft | | soft | | |
| 2-I | soft | 4 days | soft | slightly soft | soft | 4 days | soft | slightly soft | 14.5 |
| 2-J | soft | 3 days | soft | soft | soft | 3 days | soft | soft | 16.5 |
| 2-K | soft | 3 days | slightly soft | no effect | soft | 3 days | slightly soft | very slightly | 27.5 |
| | | | | | | | | soft | |
| 2-L | no effect | 3 days | no effect | no effect | very slightly | 3 days | no effect | no effect | 4.5 |
| | | | | | soft | | | | |
| 2-M | no effect | 4 days | no effect | no effect | no effect | 4 days | no effect | no effect | 14.0 |
| 2-N | soft | 4 days | soft | soft | soft | 4 days | soft | very slightly | 12.5 |
| | | | | | | | | soft | |
| 2-O | soft | 4 days | soft | no effect | soft | 4 days | slightly soft | no effect | 18.5 |
| 2-P | no effect | 2 days | no effect | no effect* | very slightly | 2 days | slightly soft | no effect* | 3.5 |
| | | | | | soft | | | | |
| 2-Q | no effect | 2 days | no effect | no effect* | no effect | 2 days | no effect | no effect* | 21.5 |
| 2-R | no effect | 2 days | no effect | no effect* | no effect | 2 days | no effect | no effect* | 5.5 |
| 2-S | sl soft | 4 days | soft | very slightly | soft | 4 days | soft | very slightly | 16.5 |
| | | | | soft | | | | soft | |
| 2-T | no effect | 4 days | soft | soft | very sl soft | 4 days | soft | soft | 8.5 |
| 2-U | soft | 4 days | soft | soft | soft | 4 days | soft | soft | 34.5 |
| 2-V | soft | 4 days | no effect | soft | soft | 4 days | very slightly | soft | 16.5 |
| | | | | | | | soft | | |
| 2-W | sl. soft | 4 days | slightly soft | slightly soft | slightly soft | 4 days | no effect | no effect | 27.0 |
| 2-X | soft | 4 days | soft | slightly soft | slightly soft | 4 days | very slightly | no effect | 14.5 |
| | | | | | | | soft | | |
| 2-Y | soft | 4 days | soft | very slightly | soft | 4 days | soft | no effect | 16.0 |
| | | | | soft | | | | | |
| 2-Z | soft | 5 days | no effect | soft | soft | 5 days | no effect | slightly soft | 8.5 |
| 2-AA | soft | 5 days | very slightly | sl soft | slightly soft | 5 days | very slightly | slightly soft | 12.0 |
| | | | soft | | | | soft | | |
| 2-AB | soft | 5 days | soft | soft | soft | 5 days | slightly soft | soft | 17.0 |
| 2-AC | soft | 5 days | soft | sot | slightly soft | 5 days | slightly soft | slightly soft | 11.5 |
| 2-AD | soft | 5 days | slightly soft | soft | soft | 5 days | slightly soft | very slightly | 7.0 |
| | | | | | | | | soft | |
| 2-AE | soft | 4 days | soft | soft | soft | 4 days | soft | soft | 5.5 |
| 2-AF | soft | 4 days | soft | soft | slightly soft | 4 days | soft | slightly soft | 8.0 |
| 2-AG | soft | 4 days | soft | soft | very slightly | 4 days | soft | soft | 6.0 |
| | | | | | soft | | | | |
| 2-AH | soft | 4 days | soft | soft | soft | 4 days | soft | slightly soft | 11.0 |
| 2-AI | soft | 4 days | soft | slightly soft | very slightly | 4 days | soft | slightly soft | 4.5 |
| | | | | | soft | | | | |

From this data, the present inventors have determined a particularly preferred coating formulation is as shown below in Table IV along with the results for this formulation in Table V.

TABLE IV

| | weight |
|---|---|
| Component 1 | |
| POLYASPARTATE A | 24.00 |
| POLYASPARTATE B | 8.00 |
| POLYASPARTATE C | 112.00 |
| ACRYLATE A | 148.0 |
| PHOTOINTIATOR A | 8.80 |
| SURFACTANT A | 3.20 |
| subtotal | 304.00 |
| Component 2 | |
| ISOCYANATE A | 96.00 |
| Subtotal | 96.00 |
| Total | 400.00 |

TABLE V

| Test | Result | |
|---|---|---|
| Viscosity | 35 | cps. |
| Pot-life | >2 | hours |
| Surface dry | 3.5 | hrs. |
| Pendulum Hardness after UV-cure | 55 | sec. |
| Pendulum Hardness 1 day after UV-cure | 69 | sec. |
| Pendulum Hardness 5 days | 86 | sec. |
| 1 hr. Gas resistance after 1 day | No effect | |
| 1 hr. IPA resistance after 1 day | No effect | |
| Taber Abrasion | 10 | mg. loss |

| | |
|---|---|
| Zipper lines after UV-cure | No |

The present inventors also assessed whether the functionality of the acrylate had any effect on the inventive coating composition. Coatings were prepared by varying the functionality of the acrylate in the formulation of Table IV. As can be appreciated by reference to Table VI below, a three-functional acrylate showed higher hardness and better abrasion resistance, while avoiding formation of zipper lines in the coating.

TABLE VI

| | ACRYLATE | | | |
|---|---|---|---|---|
| EXAMPLE | A | C | D | E |
| Acrylate Functionality | 2 | 1 | 2 | 3 |
| Viscosity (cps) | <100 | <100 | <100 | <100 |
| Pot-life (hr) | >2 | >2 | >2 | >2 |
| Surface dry (hours) | 2.5 | 2.5 | 2.0 | 2.0 |
| Pendulum Hardness after UV- | 73 | 63 | 59 | 132 |
| cure (sec.) | | | | |
| Pendulum Hardness 1 day after | 80 | 68 | 63 | 149 |
| UV-cure (sec.) | | | | |
| Pendulum Hardness 7 days | 82. | 72 | 60 | 151 |
| after UV cure (sec.) | | | | |
| 1 hr. Gas resistance after 1 day | No effect | soft | slightly | No effect |
| | | | soft | |
| 1 hr. IPA resistance after 1 day | No effect | soft | slightly | No effect |
| | | | soft | |
| Taber Abrasion | 10 mg. | 11.5 mg. | 20 mg. | 6.5 mg. |
| CS-17, 500 cy. 1000 g | loss | loss | loss | loss |
| Zipper lines after UV-cure | No | No | No | No |

This specification has been written with reference to various non-limiting and non-exhaustive embodiments. However, it will be recognized by persons having ordinary skill in the art that various substitutions, modifications, or combinations of any of the disclosed embodiments (or portions thereof) may be made within the scope of this specification. Thus, it is contemplated and understood that this specification supports additional embodiments not expressly set forth herein. Such embodiments may be obtained, for example, by combining, modifying, or reorganizing any of the disclosed steps, components, elements, features, aspects, characteristics, limitations, and the like, of the various non-limiting embodiments described in this specification. In this manner, Applicant(s) reserve the right to amend the claims during prosecution to add features as variously described in this specification, and such amendments comply with the requirements of 35 U.S.C. § 112(a), and 35 U.S.C. § 132(a).

Various aspects of the subject matter described herein are set out in the following numbered clauses:

1. A coating composition comprising: 1% to 99% of a blend of two or more aspartic ester functional amines; 20% to 70% of an acrylate-containing compound; and 20% to 70% of one or more polyisocyanates, wherein the coating composition is 100% solids and wherein the coating composition has a maximum viscosity of no more than 600 cps at one hour.

2. The coating composition according to clause 1 further including a photoinitiator.

3. The coating composition according to clause 2, wherein the photoinitiator is present in an amount of 0.1% to 5%.

4. The coating composition according to clause 1, wherein the acrylate-containing compound has a functionality of 2 or more.

5. The coating composition according to clause 1, wherein the acrylate-containing compound has a functionality of 3 or more.

6. The coating composition according to clause 1, wherein the coating composition has a maximum viscosity of no more than 100 cps at one hour.

7. The coating composition according to clause 1, wherein the acrylate-containing compound is selected from the group consisting of 1,6 hexanediol diacrylate, pentaerythritol (EO)ₙ tetraacrylate, isobornyl acrylate, tripropylene glycol diacrylate and trimethylolpropane triacrylate.

8. The coating composition according to clause 1, wherein the acrylate-containing compound is trimethylolpropane triacrylate.

9. The coating composition according to clause 2, wherein the photoinitiator is selected from the group consisting of acylphosphine oxide derivatives, α-aminoalkylphenone derivatives, hydroxyalkylphenones, benzophenones, benzil ketals, methylbenzoyl formate and phenylacetophenones.

10. The coating composition according to clause 2, wherein the photoinitiator is a 50/50 mixture of bis(2,4,6-trimethylbenzoyl)-phenylphosphineoxide and 2-hydroxy-2-methyl-1-phenyl-propan-1-one.

11. The coating composition according to clause 1, wherein the polyisocyanate is selected from the group consisting of tetramethylene diisocyanate, hexamethylene diisocyanate, 2,3,3-trimethylhexamethylene diisocyanate, 1,4-cyclohexylene diisocyanate, 4,4′-dicyclohexylmethane diisocyanate, 4,4′-dicyclohexyl diisocyanate, 1-diisocyanato-3,3,5-trimethyl-5-isocyanatomethylcyclohexane (isophorone diisocyanate), 1,4-phenylene diisocyanate, 2,6-tolylene diisocyanate, 2,4-tolylene diisocyanate, 1,5-naphthylene diisocyanate, 2,4- or 4,4′-diphenylmethane diisocyanate, α,α,α′,α′-tetramethyl-m- or -p-xylylene diisocyanate, and triphenylmethane 4,4′,4″-triisocyanate and mixtures thereof.

12. The coating composition according to clause 1, wherein the polyisocyanate is hexamethylene diisocyanate.

13. A substrate coated with the composition according to clause 1.

14. The substrate according to clause 13, wherein the substrate is selected from the group consisting of countertops and floors.

15. The substrate according to clause 13, wherein the coating composition is cured by exposure to actinic radiation.

16. A cured coating produced by exposing to actinic radiation a coating composition comprising 1% to 99% of a blend of two or more aspartic ester functional amines, 20% to 70% of an acrylate-containing compound and 20% to 70% of one or more polyisocyanates, wherein the coating composition is 100% solids and wherein the coating composition has a maximum viscosity of no more than 600 cps at one hour.

17. The cured coating according to clause 16, wherein the acrylate-containing compound is selected from the group consisting of 1,6 hexanediol diacrylate, pentaerythritol (EO)ₙ tetraacrylate, isobornyl acrylate, tripropylene glycol diacrylate and trimethylolpropane triacrylate.

18. The cured coating according to clause 16, wherein the acrylate-containing compound is trimethylolpropane triacrylate.

19. The cured coating according to clause 16, wherein the polyisocyanate is selected from the group consisting of tetramethylene diisocyanate, hexamethylene diisocyanate, 2,3,3-trimethylhexamethylene diisocyanate, 1,4-cyclohexylene diisocyanate, 4,4′-dicyclohexylmethane diisocyanate, 4,4′-dicyclohexyl diisocyanate, 1-diisocyanato-3,3,5-trimethyl-5-isocyanatomethylcyclohexane (isophorone diisocyanate), 1,4-phenylene diisocyanate, 2,6-tolylene diisocyanate, 2,4-tolylene diisocyanate, 1,5-naphthylene diisocyanate, 2,4- or 4,4′-diphenylmethane diisocyanate, α,α,α′,α′-tetramethyl-m- or -p-xylylene diisocyanate, and triphenylmethane 4,4′,4″-triisocyanate and mixtures thereof.

20. The cured coating according to clause 16, wherein the cured coating has no zipper lines.

What is claimed is:

1. A coating composition comprising:
1% to 99% of a blend of two or more aspartic ester functional amines;
1% to 99% of an acrylate-containing compound; and
10% to 70% of one or more polyisocyanates,
wherein the coating composition is 100% solids and wherein the coating composition has a maximum viscosity of no more than 600 cps at one hour.

2. The coating composition according to claim 1 further including a photoinitiator.

3. The coating composition according to claim 2, wherein the photoinitiator is present in an amount of 0.1% to 5%.

4. The coating composition according to claim 1, wherein the acrylate-containing compound has a functionality of 2 or more.

5. The coating composition according to claim 1, wherein the acrylate-containing compound has a functionality of 3 or more.

6. The coating composition according to claim 1, wherein the coating composition has a maximum viscosity of no more than 100 cps at one hour.

7. The coating composition according to claim 1, wherein the acrylate-containing compound is selected from the group consisting of 1,6-hexanediol diacrylate, pentaerythritol (EO)ₙ tetraacrylate, isobornyl acrylate, tripropylene glycol diacrylate and trimethylolpropane triacrylate.

8. The coating composition according to claim 1, wherein the acrylate-containing compound is trimethylolpropane triacrylate.

9. The coating composition according to claim 2, wherein the photoinitiator is selected from the group consisting of acylphosphine oxide derivatives, α-aminoalkylphenone derivatives, hydroxyalkylphenones, benzophenones, benzil ketals, methylbenzoyl formate and phenylacetophenones.

10. The coating composition according to claim 2, wherein the photoinitiator is a 50/50 mixture of bis(2,4,6-trimethylbenzoyl)-phenylphosphineoxide and 2-hydroxy-2-methyl-1-phenyl-propan-1-one.

11. The coating composition according to claim 1, wherein the polyisocyanate is selected from the group consisting of tetramethylene diisocyanate, hexamethylene diisocyanate, 2,3,3-trimethylhexamethylene diisocyanate, 1,4-cyclohexylene diisocyanate, 4,4′-dicyclohexylmethane diisocyanate, 4,4′-dicyclohexyl diisocyanate, 1-diisocyanato-3,3,5-trimethyl-5-isocyanatomethylcyclohexane (isophorone diisocyanate), 1,4-phenylene diisocyanate, 2,6-tolylene diisocyanate, 2,4-tolylene diisocyanate, 1,5-naphthylene diisocyanate, 2,4- or 4,4′-diphenylmethane diisocyanate, α,α,α′,α′-tetramethyl-m- or p-xylylene diisocyanate, and triphenylmethane 4,4′,4″-triisocyanate and mixtures thereof.

12. The coating composition according to claim 1, wherein the polyisocyanate is hexamethylene diisocyanate.

13. A substrate coated with the composition according to claim 1.

14. The substrate according to claim 13, wherein the substrate is selected from the group consisting of countertops and floors.

15. The substrate according to claim 13, wherein the coating composition is cured by exposure to actinic radiation.

16. A cured coating produced by exposing to actinic radiation a coating composition comprising 1% to 99% of a blend of two or more aspartic ester functional amines, 20% to 70% of an acrylate-containing compound and 20% to 70% of one or more polyisocyanates, wherein the coating composition is 100% solids and wherein the coating composition has a maximum viscosity of no more than 600 cps at one hour.

17. The cured coating according to claim 16, wherein the acrylate-containing compound is selected from the group consisting of 1,6 hexanediol diacrylate, pentaerythritol (EO)ₙ tetraacrylate, isobornyl acrylate, tripropylene glycol diacrylate and trimethylolpropane triacrylate.

18. The cured coating according to claim 16, wherein the acrylate-containing compound is trimethylolpropane triacrylate.

19. The cured coating according to claim 16, wherein the polyisocyanate is selected from the group consisting of tetramethylene diisocyanate, hexamethylene diisocyanate, 2,3,3-trimethylhexamethylene diisocyanate, 1,4-cyclohexylene diisocyanate, 4,4′-dicyclohexylmethane diisocyanate, 4,4′-dicyclohexyl diisocyanate, 1-diisocyanato-3,3,5-trimethyl-5-isocyanatomethylcyclohexane (isophorone diisocyanate), 1,4-phenylene diisocyanate, 2,6-tolylene diisocyanate, 2,4-tolylene diisocyanate, 1,5-naphthylene diisocyanate, 2,4- or 4,4′-diphenylmethane diisocyanate, α,α,α′,α′-tetramethyl-m- or -p-xylylene diisocyanate, and triphenylmethane 4,4′,4″-triisocyanate and mixtures thereof.

20. The cured coating according to claim 16, wherein the cured coating has no zipper lines.
